(19) United States
(12) Patent Application Publication
(10) Pub. No.: US 2026/0113291 A1
(43) Pub. Date: Apr. 23, 2026

(54) INTERNAL EMAIL FILTERING

(71) Applicant: Open Text Holdings, Inc., Menlo Park, CA (US)

(72) Inventors: Cara Joy Drye, Pensacola, FL (US); Michael Patrick Bower, Milton, FL (US); Roger Brassard, Longview, TX (US); Troy Gill, Pensacola, FL (US)

(21) Appl. No.: 18/921,955

(22) Filed: Oct. 21, 2024

(51) Int. Cl. H04L 51/212; H04L 51/234

(52) U.S. Cl. CPC H04L 51/212; H04L 51/234

(57) ABSTRACT

Systems and methods for internal email filtering are provided. Various embodiments of the present technology provide systems and methods for improved email filtering including a dedicated internal email filtering process designed to intercept all emails exchanged within the organization and detect whether the email is internal or external. The system scans each internal email to detect potential threats, such as viruses, malware, or phishing attempts, and immediately quarantines any identified threats, preventing the email from being delivered to the intended recipient. The system also targets harmful attachments, isolating them to ensure they do not reach users, and safeguards against malicious links by identifying and safeguarding them (e.g., blocking, wrapping, checking, etc.) before they can be clicked. If an email is deemed not to be a security threat, it is safely delivered to the intended recipient, ensuring seamless and secure internal communication.

### TECHNICAL FIELD

This disclosure relates generally to email processing at ingress servers. More particularly, this disclosure relates to systems, methods, and computer program products for internal email filtering.

### BACKGROUND

Computing devices operating in networked computing environments can be infected by email-borne threats sent to users. There is a default trust for emails sent between internal users (i.e., users who belong to an organization using its internal email system, typically sharing the same email domain). However, there is still much risk, even between pure internal email transactions.

Conventional systems may take a copy of an internal email (while the email is also delivered to the intended recipient), process the email copy, and if the email is determined to be a security threat, it is retracted from the recipient's email inbox. However, one disadvantage of this process is that the inbox retraction is not immediate, and the user (email recipient) may have already opened the email in their inbox, exposing the threat. Additionally, there is a potential for the retraction to fail, leaving the malicious email in the user's inbox.

There is a need for systems that process internal emails for security issues to filter out those that pose a security threat that overcome problems in the art.

### SUMMARY

Systems and methods for internal email filtering are described that, in some embodiments, include receiving an email message, intercepting the email message, determining whether the email message is an external email message or an internal email message. When it is determined that the email message is an external email message, processing the external email message in a first manner. When it is determined that the email message is an internal email message, filtering the email message to detect threats, and when a threat is detected, stopping the delivery of the email message. In some embodiments, when a threat is detected, delivery of the email message is stopped, and the email message is removed from the sent folder of the sender's mailbox.

Embodiments of the present invention may also include computer-readable storage media containing sets of instructions to cause one or more processors to perform the methods, variations of the methods, and other operations described herein.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE FIGURES

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 is a flow diagram depicting an internal email filtering system.

FIG. 2 is a flow diagram depicting an email processing workflow.

FIG. 3 is a flow diagram depicting an internal email processing workflow.

FIG. 4 is a flow diagram depicting an internal email processing workflow, including message retraction.

FIG. 5 depicts a diagrammatic representation of a distributed network computing environment where embodiments disclosed can be implemented.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

The present disclosure describes a system and method that provides improved handling of internal emails in an organization for purposes of preventing or mitigating risks from malicious emails, such as malware and viruses, phishing, email spoofing, and other attacks. An “internal email” can be considered to be email communications originating within an organization using the organization's internal email system. Typically, this may include employees or other individuals who have email accounts under the organization's domain. In a typical enterprise environment, internal users may use the same domain, often associated with an organization's brand or business. Emails sent between internal users are often subject to company-specific policies and security protocols, such as encryption, monitoring, data retention, etc. Internal users may also generally have access to shared resources like calendars, contact directories, and document management systems that are tied to the organization's email system. While there is a default trust for emails sent between internal users, there is still much risk, even between pure internal email transactions.

Generally, as described in detail below, an email filtering system includes a dedicated internal email filtering process designed to intercept all emails exchanged within the organization. It thoroughly scans each email to detect potential threats, such as viruses, malware, or phishing attempts, and immediately quarantines any identified threats, preventing the email from being delivered to the intended recipient. The system also targets harmful attachments, isolating them to ensure they do not reach users, and safeguards against malicious links by identifying and safeguarding them (e.g., blocking, wrapping, checking, etc.) before they can be clicked. If an email is deemed not to be a security threat, it is safely delivered to the intended recipient, ensuring seamless and secure internal communication.

One advantage of this email filtering system lies in its ability to provide proactive security without disrupting workflow. By intercepting and analyzing all internal emails, the system ensures that potential threats are neutralized before they can cause harm, reducing the risk of data breaches or malware spreading within the organization. Its ability to quarantine suspicious content—whether harmful attachments or malicious links—protects users from inadvertently compromising the network. Additionally, the system delivers non-threatening emails promptly, maintaining smooth communication and productivity while providing a strong defense against evolving email-borne threats. This approach strengthens overall security without hindering operational efficiency.

An additional feature of this email filtering system is the ability to retract email records from the internal sender, provided the customer has granted permission for this action within their internal system. This functionality ensures that any email flagged as a security threat or containing harmful content can be completely removed from the sender's outbox, preventing it from being sent again. This capability not only helps in mitigating risks associated with the inadvertent dissemination of harmful emails but also reinforces the integrity of the organization's email practices by ensuring that once a threat is identified, it minimizes recurrence from the same source. This proactive measure adds another layer of security, enhancing overall protection against internal email threats.

Internal and external emails are filtered through distinct processes to ensure optimal security and efficiency. Internal emails adhere to the disclosed specialized filtering process designed to address threats specific to internal communications, such as insider threats or malware that may be inadvertently shared. In contrast, external emails, coming from outside the organization, are subjected to a different set of filters that may focus on blocking spam, phishing attempts, and other external threats. By employing separate filtering mechanisms for internal and external emails, the system provides tailored protection that addresses the unique risks associated with each type of communication, enhancing overall security and maintaining operational integrity.

In the following section, a comprehensive overview of one embodiment of an email filtering system is provided, illustrated through a detailed flow diagram. This diagram visually represents the various stages of the email processing workflow, from initial interception and threat detection to the final delivery or quarantine of emails. The email filtering system will be described in the context of Office 365, though it is applicable to other email platforms such as Google, Exchange, and various enterprise email solutions, as one skilled in the art will understand.

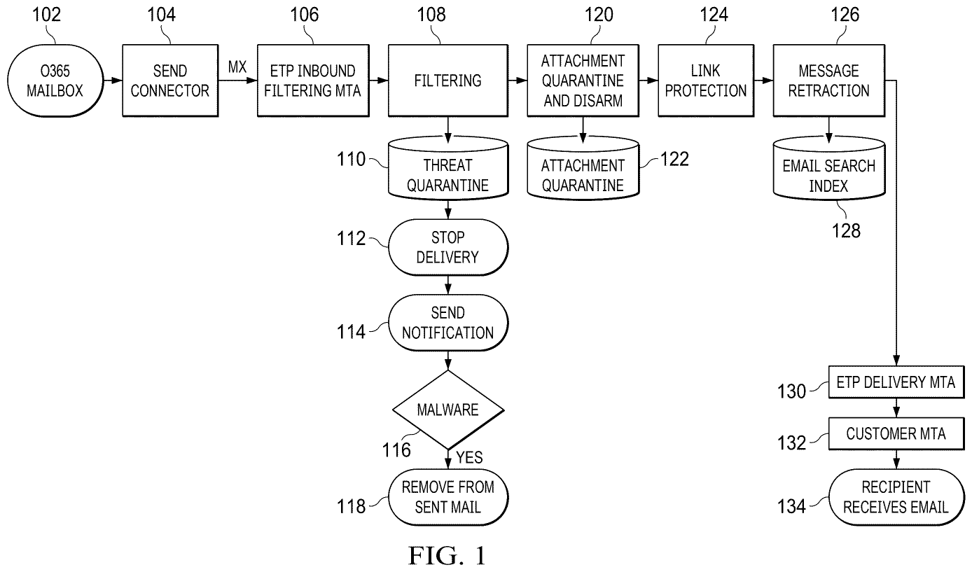

FIG. 1 is a flow diagram depicting one embodiment of an internal email filtering system. When an email is identified as an internal email, the email is processed as illustrated in FIG. 1. Note that, in a typical enterprise implementation multiple servers may be used together for a given domain and load balanced via the email threat protection (EMT) inbound filtering mail transfer agent (MTA) 106 (described below).

An email inbox 102 (e.g., an Office 365 inbox) is shown in FIG. 1. In the example of Office 365, an administrator can use the Office 365 admin center and set internal email to be intercepted, as one skilled in the art would understand. In addition, a mail header can be injected (and a secret key included that is associated with an organization) that identifies the email as internal. From the Office 365 admin center, the administrator can also set up the connectors (see send connector 104 in FIG. 1). In some embodiments, the administrator creates a connector for a connection from Office 365 to a “Partner organization”, names the connector, and turns it on with a checkbox. The administrator can also set other settings, relating to transport rules, MX records, validation emails, etc. Note that the send connector 104 is an item defined by Office 365. Other email platforms enable different, but similar configurations to achieve similar functionalities.

Thereafter, when an internal user to internal user email is sent, the send connector 104 triggers a rule that sends the email via the MX records to the MTA 106. In other words, the email is intercepted by the system. As mentioned above, the EMT inbound filtering MTA 106 can act as a load balancer for multiple servers that perform the subsequent filtering steps. Generally, the MTA 106 is responsible for routing and delivering email messages between servers using protocols such as SMTP (Simple Mail Transfer Protocol).

For a given internal email message, the MTA 106 (load balancer) sends the message to filter 108 for processing. The filtering 108 step detects threats in the email message, for example, spam, malware, phishing, etc., and other email-borne threats. When a threat is found, the email is quarantined (threat quarantine 110). In addition, delivery of the mail is stopped (stop delivery 112). In some embodiments, a notification is sent (send notification 114), for example, to an administrator or the intended recipient. In some embodiments, if malware (or other threat) is detected (Malware 116), then the email is removed from the outbox or sent folder of the sender (remove from sent email 118). As mentioned above, one optional feature of the email filtering system is the ability to retract email records from the internal sender. This ensures that any email flagged as a security threat or containing harmful content can be completely removed from the sender's outbox, preventing it from being sent again.

If the filtering 108 does not detect a threat, the email is checked for harmful attachments (attachment quarantine and disarm 120) and harmful links (link protection 124). If a harmful email attachment is detected, an attachment quarantine service (AQS) will hold the email attachment in quarantine (attachment quarantine 122). In some embodiments, the intended recipient may receive an email notifying the recipient that an attachment is being held. The user can then click a link to notify an administrator to check out the attachment. If a harmful link is detected at link protection 124, the intended recipient can receive the original email with the link modified. The system can modify the link in a number of ways to mitigate the threat. For example, the system may use URL wrapping (replacing the original URL with a redirect that passes through a security gateway), safety checks (the system scans the destination URL for known threats), link masking (redirecting the link through a safe, monitored service), or in other ways.

If desired, a message can be retracted (message retraction 126). For example, an administrator can, via a customer portal, retract a message from a user. Retracted email messages can be stored and indexed in email search index 128. In some embodiments, a user can search and view retracted messages via the customer portal.

If an email message makes it through the filtering, attachment quarantine, and link protection steps, the email is delivered to the intended recipient (recipient receives email 134) via the ETP delivery MTA 130 and the customer MTA 132. Note that “customer” in “customer MTA” refers to an internal user (i.e., a customer of the filtering service).

In FIG. 1, filtering 108, attachment quarantine and disarm 120, link protection 124, and message retraction 126 are services provided by the system. Send connector 104, EMT inbound filtering MTA 106, ETP delivery MTA 130 and customer MTA 132 are part of mail transfer agents. Threat quarantine 110, attachment quarantine 122, and email search index 128 are data stores.

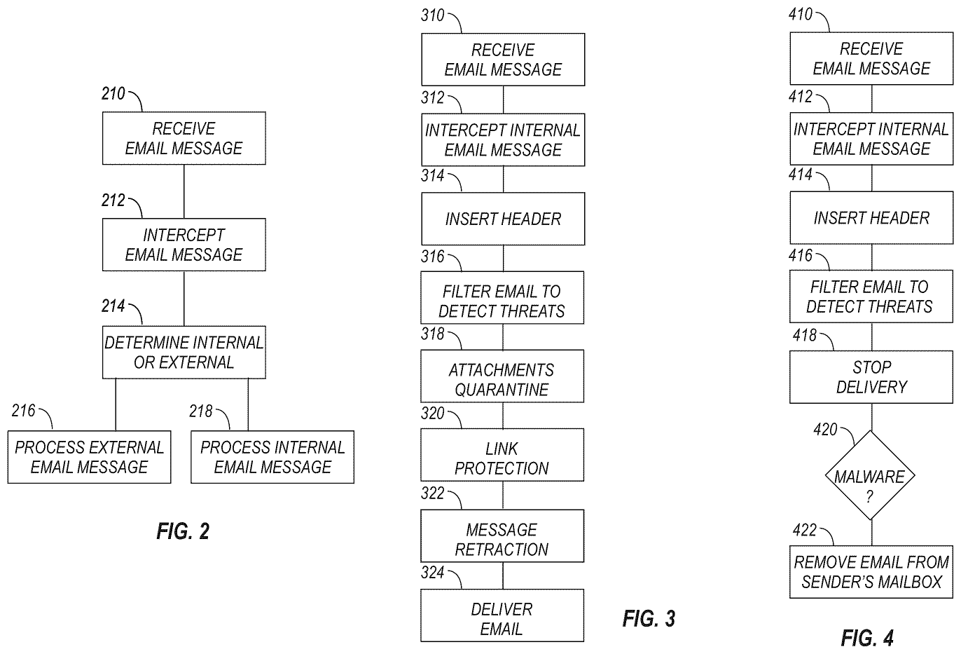

FIGS. 2-4 are flow charts illustrating several exemplary email filtering processes. FIG. 2 is a flowchart showing an internal and external email filtering process. At step 210, an email message is received. The system intercepts the email message at step 212. At step 214, the system determines whether the email message is an external or internal email message, for example, based on a header inserted not the message (discussed above). If the email is an external email message, the message is processed using filters and rules configured for external email messages (step 216). If the email is an internal email, the message is processed using a different set of filters and rules (discussed in detail above) configured for internal email messages (step 218). An example of internal email filtering is illustrated in FIG. 3.

FIG. 3 is a flowchart showing an internal email filtering process. At step 310, an email message is received. The system intercepts the email message at step 312. At step 314, the system injects a header into the message (discussed in detail above), which identifies the message as internal. The header includes a secret key. At step 316, the email is filtered to detect threats. If a threat is detected, the system addresses the threat, as described in detail above, with respect to FIG. 1. The system also checks for harmful attachments, and if found places the attachment in quarantine (step 318). At step 320, the system detects harmful links. If a harmful link is detected, the system addresses the link, as described in detail above, with respect to FIG. 1. If desired, an administrator, or other user can retract a message (step 322), as discussed in detail above. If the system determines that there are no threats, or that the threats are addressed via attachment quarantine or link wrapping, the email message is delivered to the intended recipient (step 324).

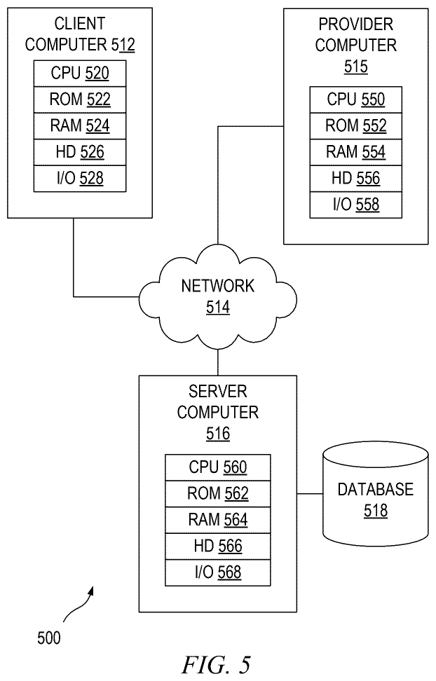

FIG. 5 is a flowchart showing an internal email filtering process, including message removal at the sender's mailbox. At step 410, an email message is received. The system intercepts the email message at step 312. At step 414, the system injects a header into the message (discussed in detail above), which identifies the message as internal. The header may also include a secret key. At step 416, the email is filtered to detect threats. If a threat is detected, the system stops delivery (step 418). The system also provides the ability to remove the sent email from the sender's mailbox (step 422) of a threat, such as malware is detected (step 420). This feature is discussed in detail above. Note that the steps shown in FIGS. 2-4, for clarity, do not show all steps. For example, in all of the examples, the system will still process external email.

FIG. 5 depicts a diagrammatic representation of a distributed network computing environment where embodiments disclosed can be implemented. In the example illustrated, network computing environment 500 includes network 514 that can be bi-directionally coupled to computer 512, computer 515, and computer 516. Computer 516 can be bi-directionally coupled to data store 518. Network 514 may represent a combination of wired and wireless networks that network computing environment 500 may utilize for various types of network communications known to those skilled in the art.

For the purpose of illustration, a single system is shown for each of computer 512, computer 515, and computer 516. However, with each of computer 512, computer 515, and computer 516, a plurality of computers (not shown) may be interconnected to each other over network 514. For example, a plurality of computers 512 and a plurality of computers 515 may be coupled to network 514. Computers 512 may include data processing systems for communicating with computer 516. Computers 515 may include data processing systems for providing blocked lists to computer 516.

First enterprise computer 512 can include central processing unit (“CPU”) 520, read-only memory (“ROM”) 522, random access memory (“RAM”) 524, hard drive (“HD”) or storage memory 526, and input/output device(s) (“I/O”) 528. I/O 529 can include a keyboard, monitor, printer, electronic pointing device (e.g., mouse, trackball, stylus, etc.), or the like. Computer 512 can include a desktop computer, a laptop computer, a personal digital assistant, a cellular phone, or nearly any device capable of communicating over a network. Computer 515 may be similar to computer 512 and can comprise CPU 550, ROM 552, RAM 554, HD 556, and I/O 558.

Likewise, computer 516 may include CPU 560, ROM 562, RAM 564, HD 566, and I/O 568. Computer 516 may include one or more backend systems configured for providing a variety of services (e.g., an email-to-fax service) to computers 512 over network 514. These services may utilize data stored in data store 518. Many other alternative configurations are possible and known to skilled artisans.

Each of the computers in FIG. 5 may have more than one CPU, ROM, RAM, HD, I/O, or other hardware components. For the sake of brevity, each computer is illustrated as having one of each of the hardware components, even if more than one is used. Each of computers 512, 515, and 516 is an example of a data processing system. ROM 522, 552, and 562; RAM 524, 554, and 564; HD 526, 556, and 566; and data store 518 can include media that can be read by CPU 520, 550, or 560. Therefore, these types of memories include non-transitory computer-readable storage media. These memories may be internal or external to computers 512, 515, or 516.

Portions of the methods described herein may be implemented in suitable software code that may reside within ROM 522, 552, or 562; RAM 524, 554, or 564; or HD 526, 556, or 566. In addition to those types of memories, the instructions in an embodiment disclosed herein may be contained on a data storage device with a different computer-readable storage medium, such as a hard disk. Alternatively, the instructions may be stored as software code elements on volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, hosted or cloud-based storage, and other appropriate computer memories and data storage devices.

Although the invention has been described with respect to specific embodiments thereof, these embodiments are merely illustrative, and not restrictive of the invention as a whole. Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Software implementing embodiments disclosed herein may be implemented in suitable computer-executable instructions that may reside on a computer-readable storage medium. Within this disclosure, the term “computer-readable storage medium” encompasses all types of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, hosted or cloud-based storage, and other appropriate computer memories and data storage devices.

Those skilled in the relevant art will appreciate that the invention can be implemented or practiced with other computer system configurations including, without limitation, multi-processor systems, network devices, mini-computers, mainframe computers, data processors, and the like. The invention can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. At least portions of the functionalities or processes described herein can be implemented in suitable computer-executable instructions. The computer-executable instructions may reside on a computer readable medium, hardware circuitry or the like, or any combination thereof.

Any suitable programming language can be used to implement the routines, methods or programs of embodiments of the invention described herein, including C, C++, Java, JavaScript, HTML, or any other programming or scripting code, etc. Different programming techniques can be employed such as procedural or object oriented. Other software/hardware/network architectures may be used. Communications between computers implementing embodiments can be accomplished using any electronic, optical, radio frequency signals, or other suitable methods and tools of communication in compliance with known network protocols.

As one skilled in the art can appreciate, a computer program product implementing an embodiment disclosed herein may comprise a non-transitory computer readable medium storing computer instructions executable by one or more processors in a computing environment. The computer readable medium can be, by way of example only but not by limitation, an electronic, magnetic, optical or other machine readable medium. Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices.

Particular routines can execute on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps and operations described herein can be performed in hardware, software, firmware or any combination thereof.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Generally then, although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

What is claimed IS:

1. An email filtering method comprising:
receiving, by a mail server, an email message;
intercepting, by a mail transfer agent, the email message;
determining, by the mail server, whether the email message is an external email message or an internal email message;
when it is determined that the email message is an external email message, processing the external email message;
when it is determined that the email message is an internal email message:
filtering the email message to detect threats; and
when a threat is detected, stopping the delivery of the email message.

2. The method of claim 1, further comprising:
when it is determined that the email message is an internal email message, inserting a header into the email message identifying the email message as internal.

3. The method of claim 2, further comprising inserting a secret key into the header.

4. The method of claim 1, wherein filtering the email message further comprises detecting harmful email attachments in the email message.

5. The method of claim 1, wherein filtering the email message further comprises detecting harmful links in the email message.

6. The method of claim 1, further comprising:
when it is determined that the email message is an internal email message, enabling a user to retract the email message.

7. The method of claim 1, further comprising:
when a threat is detected:
stopping the delivery of the email message; and
removing the email message from a sent folder in a mailbox of a sender of the email.

8. An internal email filtering method comprising:
receiving, by a mail server, an email message;
intercepting, by a mail transfer agent, the email message;
determining, by the mail server, that the email message is an internal email message;
filtering the email message to detect threats; and
when a threat is detected, stopping the delivery of the email message.

9. The method of claim 8, further comprising:
when it is determined that the email message is an internal email message, inserting a header into the email message identifying the email message as internal.

10. The method of claim 9, further comprising inserting a secret key into the header.

11. The method of claim 8, wherein filtering the email message further comprises detecting harmful email attachments in the email message.

12. The method of claim 8, wherein filtering the email message further comprises detecting harmful links in the email message.

13. The method of claim 8, further comprising:
when it is determined that the email message is an internal email message, enabling a user to retract the email message.

14. The method of claim 8, further comprising:
when a threat is detected:
stopping the delivery of the email message; and
removing the email message from a sent folder in a mailbox of a sender of the email.

15. An internal email filtering method comprising:
receiving, by a mail server, an email message originating from a first user;
intercepting, by a mail transfer agent, the email message;
determining, by the mail server, that the email message is an internal email message;
filtering the email message to detect threats;
when a threat is detected:
stopping the delivery of the email message; and
removing the email message from a sent folder in a mailbox of the first user.

16. The method of claim 15, further comprising:
when it is determined that the email message is an internal email message, inserting a header into the email message identifying the email message as internal.

17. The method of claim 16, further comprising inserting a secret key into the header.

18. The method of claim 15, wherein filtering the email message further comprises detecting harmful email attachments in the email message.

19. The method of claim 15, wherein filtering the email message further comprises detecting harmful links in the email message.

20. The method of claim 15, further comprising:
when it is determined that the email message is an internal email message, enabling a user to retract the email message.
